(19) United States
(12) Patent Application Publication
(10) Pub. No.: US 2024/0351835 A1
(43) Pub. Date: Oct. 24, 2024

(54) Battery Powered Vehicle Jack

(71) Applicant: Milwaukee Electric Tool Corporation, Brookfield, WI (US)

(72) Inventors: Josh Kath, Brookfield, WI (US); Nick Doucette, Brookfield, WI (US); Kira Sosinske, Brookfield, WI (US); Trenton Nix, Brookfield, WI (US); Hannah Loukusa, Brookfield, WI (US); Jacob Seifert, Brookfield, WI (US)

(21) Appl. No.: 18/632,174

(22) Filed: Apr. 10, 2024

Related U.S. Application Data
(60) Provisional application No. 63/496,905, filed on Apr. 18, 2023.

(51) Int. Cl. B66F 5/02

(52) U.S. Cl. CPC B66F 5/025; B66F 2700/04

(57) ABSTRACT

A vehicle jack, such as a battery-operated vehicle jack is provided. The jack includes a base, a lift arm, a crank arm, an actuator coupled to the lift arm and an electric motor to actuate the actuator. The lift arm includes a first end that engages a load and a second end that is moveably coupled to the base. The crank arm includes a third end that is pivotally coupled to the base and a fourth end that is pivotally coupled to the lift arm between the first end and the second end. The electric motor actuates the actuator to move the second end of the lift arm relative to the third end of the crank arm to cause a vertical movement at the first end of the lift arm between a lowered position and a raised position.

### CROSS-REFERENCE TO RELATED APPLICATIONS

This application claims the benefit of U.S. Provisional Application No. 63/496,905, filed Apr. 18, 2023, which is herein incorporated by reference in its entirety.

### BACKGROUND

Vehicle jacks (e.g., portable vehicle jacks) are typically used to lift a vehicle, such as a car, truck, or other vehicle in order to perform maintenance or other work on the vehicle. In one example, to lift the vehicle, a user typically manually adjusts the jack (e.g., via a hand lever, crank, etc.) to raise (or lower) the jack. This process can be tiring and potentially dangerous for a user. Electric vehicle jacks, which may require less manual adjustment, typically rely on battery power supplied via the vehicle battery, which can deplete or potentially damage the vehicle battery. Thus, there is a desire to provide a vehicle jack that requires less manual adjustment without relying on the use of the vehicle battery.

### SUMMARY

Some embodiments of the invention provide a vehicle jack, such as a battery-operated vehicle jack. The jack may include a base, a lift arm, a crank arm, an actuator coupled to the lift arm and an electric motor to actuate the actuator. The lift arm may include a first end that engages a load and a second end that is moveably coupled to the base. The crank arm may include a third end that is pivotally coupled to the base and a fourth end that is pivotally coupled to the lift arm between the first end and the second end. The electric motor may actuate the actuator to move the second end of the lift arm relative to the third end of the crank arm to cause a vertical movement at the first end of the lift arm between a lowered position and a raised position.

Some embodiments of the invention provide a vehicle jack, such as a battery-operated vehicle jack. In one example, the jack may include a base coupled to a battery, a carriage moveably coupled to translate along the base, the carriage including a drive nut, a saddle configurated to engage a vehicle, a lift arm including a first end pivotally coupled to the saddle to define a first axis and a second end pivotally coupled to the carriage to define a second axis, a crank arm with a third end that is pivotally coupled to the base to define a third axis and a fourth end that is pivotally coupled to the lift arm to define a fourth axis that is between the first axis and the second axis, a lead screw threadably engaged with the drive nut, and an electric motor configured to receive power from the battery and operable rotate the lead screw to adjust an angle between the lift arm and the crank arm to move the vehicle jack between a raised position corresponding to a minimum value of the angle and a lowered position corresponding to a maximum value of the angle.

Some embodiments of the invention provide a vehicle jack, such as a battery-operated vehicle jack. The jack may include a base configured to couple to a battery, the base including a first sidewall defining a first slot, a second sidewall defining a second slot, and a bracket between the first sidewall and the second sidewall, a carriage movably coupled to translate along the base, the carriage include a drive nut, a first pad that is received in the first slot, and a second pad that is received in the second slot, a saddle configured to engage a vehicle, a lift arm positioned between the first sidewall and the second sidewall, the lift arm including a first end pivotally coupled to the saddle to define a first axis and a second end defining a yoke that is pivotally coupled to the carriage to define a second axis, a crank arm with a third end that is pivotally coupled to the bracket and a fourth end that is pivotally coupled to the lift arm to define a fourth axis that is between the first axis and the second axis, a lead screw threadably engaged with the drive nut the lead screw having a first end that is rotatably coupled to the bracket, and an electric motor configured to receive power from the battery and coupled to a second end of the lead screw to rotate the lead screw to adjust to cause a vertical movement at a first end of the lift arm between a lowered position corresponding to a maximum angle between the lift arm and the crank arm and a raised position corresponding to a minimum angle between the lift arm and the crank arm.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a side view of one example of a vehicle jack according to aspects of the present disclosure.

FIG. 2 is a perspective view of a lift mechanism of the vehicle jack of FIG. 1.

FIG. 3 is another perspective view of the lift mechanism of FIG. 2.

FIG. 4 is a side view of the lift mechanism of FIG. 2.

FIG. 5 is a rear view of the lift mechanism of FIG. 2.

FIG. 6 is a top view of the lift mechanism of FIG. 2.

FIG. 7 is a side view of another example of a vehicle jack according to aspects of the present disclosure.

FIG. 8 is a perspective view of a lift mechanism of the vehicle jack of FIG. 7.

FIG. 9 is another perspective view of the lift mechanism of FIG. 7.

FIG. 10 is a perspective view of a lift arm of the lift mechanism of FIG. 8.

FIG. 11 is a perspective partial view of the lift mechanism of FIG. 8 including a locking mechanism.

FIG. 12 is a front view of a release handle of the locking mechanism of FIG. 11.

FIG. 13 is a schematic view of the lift mechanisms of FIGS. 2 and 8.

FIG. 14 is a cross-sectional view of a drive mechanism for use with the vehicle jacks of FIGS. 1 and 7.

FIG. 15 is a perspective view of an example of a coupler arranged between the drive mechanism of FIG. 14 and a lift mechanism.

FIG. 16 is a graph of lift power vs. lift angle for the vehicle jacks of FIGS. 1 and 7.

FIG. 17 is a graph of mechanical advantage vs. lift angle for the vehicle jacks of FIGS. 1 and 7.

FIG. 18 is a graph of torque required vs. lift angle for the vehicle jacks of FIGS. 1 and 7.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Vehicle jacks can be used to lift vehicles to provide improve access to vehicle components, including for vehicle maintenance, replacement of tires, or other uses. In some cases, jacks are configured as portable vehicle jacks that can be moved to a location of a vehicle or stored onboard a vehicle (e.g., for emergency maintenance). Conventional portable jacks typically require manual operation to raise and lower the jack. For example, a conventional portable jack may include a crank arm that is rotated by a user to raise and lower the jack, or a pump lever that can pumped by a user to raise and lower the jack. These types of systems can be difficult to use as they require a user to have adequate strength to operate the jack. In addition, placement of the jack or maintaining the jack in an upright position for lifting can be challenging due to the large input forces applied by the user, particularly when the jack is being used on an uneven or unstable surface (e.g., a gravel pad, shoulder of a road, etc.).

To provide greater ease of use, the present disclosure provides a (portable) jack that is electrically operated to raise and lower a jack. In this way, the vehicle jack may permit a user to lift or lower the vehicle without force applied by the user. Thus, following placement of the jack by the user at a desired (e.g., a lift point on the load), the user can operate the jack by simply pushing a button. The jack includes a drive system (e.g., a motor, controller, power source, etc.) that is configured to operating a lifting system, which is configured to engage and lift a load. In some examples, the jack may include a battery powered drive mechanism, which lifts or lowers the vehicle via actuation of a button or switch by a user. In some examples, the lifting system can incorporate a linkage system that is driven by an actuator (e.g., a lead screw, hydraulic piston, etc.) to cause extension and retraction of the jack. Extension and retraction of the jack can cause (vertical) linear motion at a load saddle that engages with the load. The linkage system can be configured to provide increased mechanical advantage over the stroke of the jack (e.g., movement between an extended position (e.g., a raised position) and a retracted position (e.g., a lowered position) of the jack. In one example, the linkage system can be configured to provide increasing mechanical advantage as it moves from the retracted position to the extended position. In some examples, the jack can include a locking system to lock jack at a desired height and prevent unwanted retraction. The locking system can be provided as a discrete locking system or it can be provided by components of the lifting system (e.g., a self-locking lead screw).

In some examples, a jack according to the present disclosure can be configured as a portable vehicle jack that is configured to raise and lower a vehicle. Vehicle jacks can come in a variety of lift capacities and sized according to the type of load being lifted (e.g., sedan, pickup truck, etc.) In one example, a vehicle jack can be configured to lift a vehicle at least six (6) inches vertically to permit a user to change a tire. To facilitate rapid maintenance of the vehicle, the jack may fully lift or lower the vehicle in less than 90 seconds. The jack may further include a lifting capacity of at least 1.5 tons.

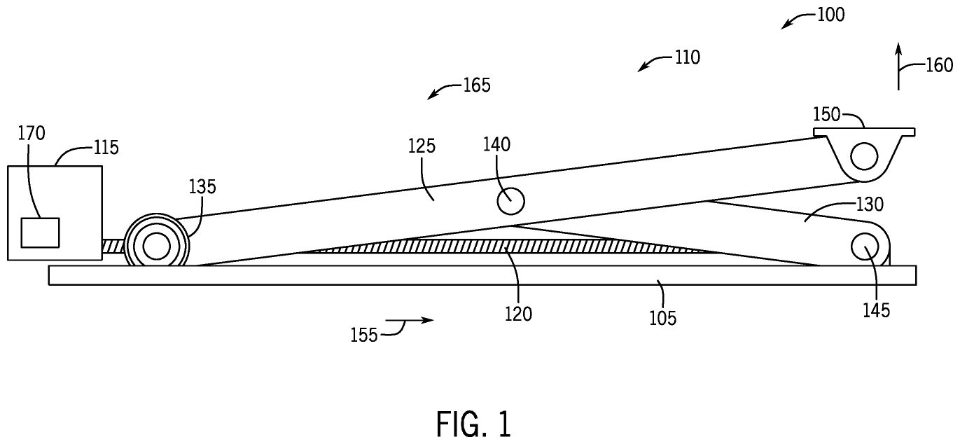

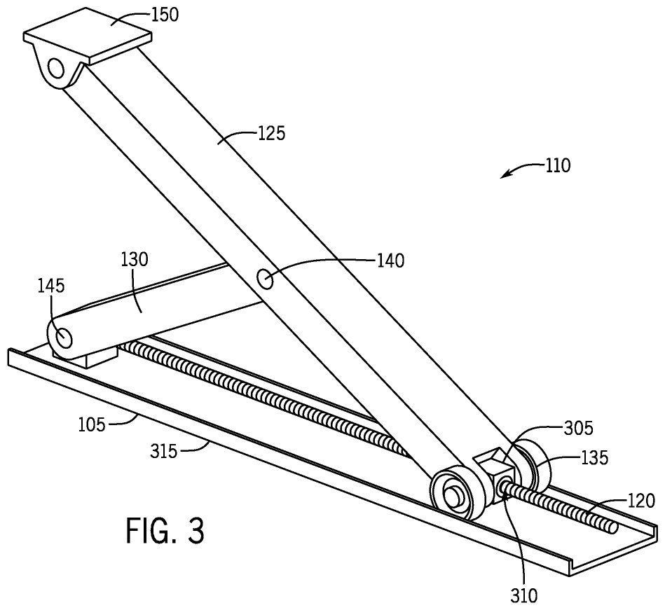

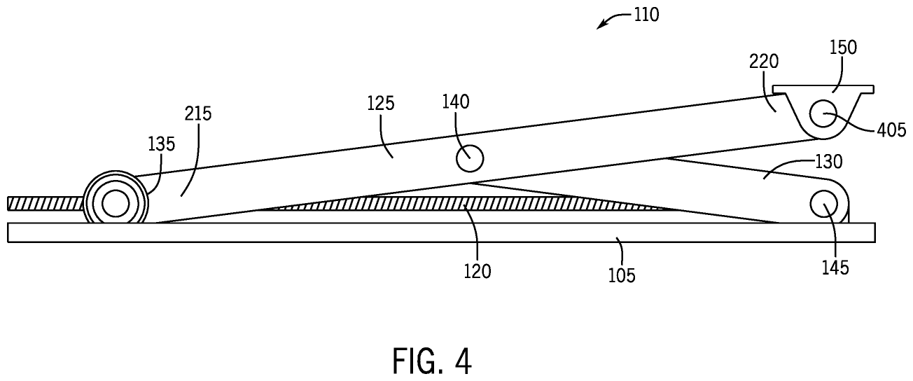

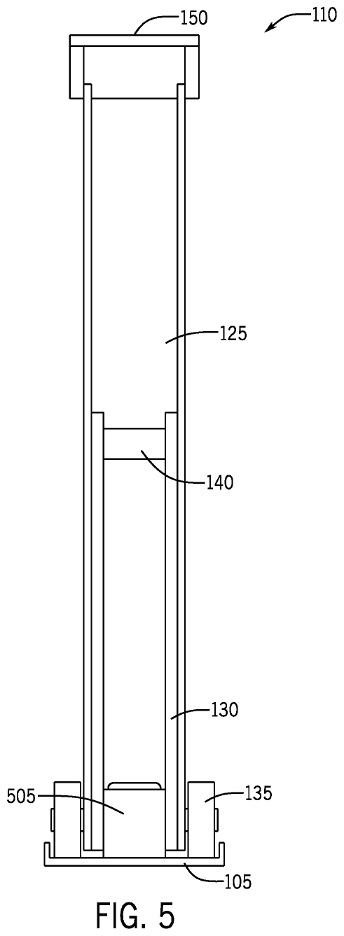

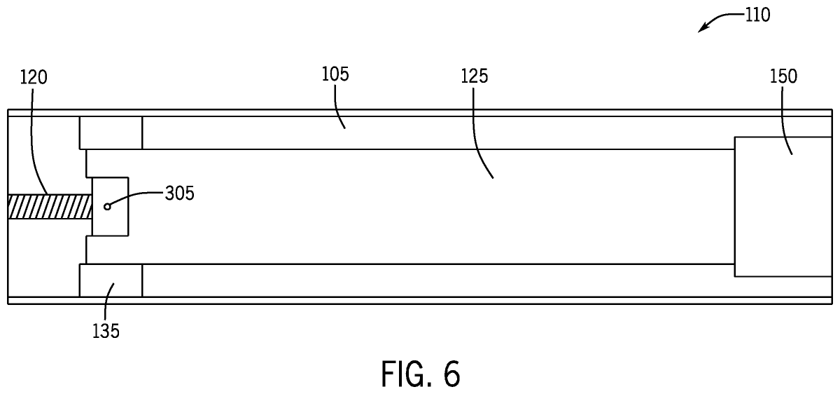

FIGS. 1-6 illustrate an example of a vehicle jack 100 configured to lift a vehicle, such as a car, truck, or other vehicle, with minimal or no force input from a user. The jack 100 may include a base 105, which provides a stable, sturdy lifting platform for the jack 100. In one example, the base 105 may be a flat rectangular base made from metal. In other examples, the base 105 may be other shapes, such as circular, polygonal, or any combination thereof. The base may include fixed or adjustable feet to allow for stable positioning on a variety of support surfaces. In one example, the base 105 supports a lift mechanism 110 configured to lift or raise a vehicle. In one particular example, the base 105 may include sidewalls 315 configured to retain a portion of the lift mechanism 110 (e.g., guide lineal movement of the lift mechanism). To facilitate movement (e.g., to raise or lower) of the lift mechanism 110, the lift mechanism 110 may be powered (e.g., raised or lowered) via a drive mechanism 115. In one example, the drive mechanism 115 may include an electronic power source 170, such as a battery configured to drive an electric motor.

The lift mechanism 110 may include a lift arm 125 (e.g., a first link) coupled to a crank arm 130 (e.g., a second link). In one example, the lift arm 125 may be connected to the crank arm 130 via a fastener 140 (e.g., a pin, bolt, etc.), which may form a pivot point of the lift arm 125 with regard to the crank arm 130. In this way the lift arm 125 and the crank arm 130 rotate relative to one another at the fastener 140. In one example, the lift arm 125 may be connected to the crank arm 130 via the fastener 140 so that the lift arm 125 may rotate (e.g., pivot) about an axis (e.g., a fourth axis) defined by the fastener 140. In one example, the lift arm 125 may rotate about 90-degrees around the fastener 140. In another example, the lift arm 125 may rotate between about 75 and about 90-degrees around the fastener 140. In one example, the crank arm 130 is coupled to the lift arm 125 between a first end 220 of the lift arm 125 that engages with a load (e.g., the vehicle) and a second end 215 of the lift arm 125 that engages with the base 105 (e.g., via a connection configured to allow for sliding motion therebetween). More specifically, the crank arm 130 can be coupled to the lift arm 125 at about a midpoint of the lift arm 125 (e.g., a center of a distance between the first end 220 and the second end 212). Accordingly, as described in greater detail below, horizontal movement (e.g., as shown by arrow 155) of the second end 215 of the lift arm 125 toward the crank arm 130 generates corresponding vertical movement (e.g., shown by arrow 160) in the first end 220 of the lift arm 125. Thus, as the second end 215 of the lift arm 125 moves horizontally (e.g., nearer to the crank arm) the first end 220 of the lift arm 125 moves vertically, which raises the lift mechanism and thus may lift a vehicle or other object. The relative pivotal generated between the lift arm 125 and the crank arm 130 causes linear motion at each of the first end 220 and the second end 215 of the lift arm 125. In this case, the first end 220 moves in a first direction (e.g., vertical direction to cause lifting) and the second end 215 moves in a second direction (e.g., a horizontal direction) that is perpendicular to the first direction.

In one example, the crank arm 130 is pivotally coupled to the lift arm 125 at a first end 205 and to the base 105 at a second 210 that is opposite the first end 205. The crank arm 130 is coupled to the base 105 at a fixed pivot connection and coupled to the lift arm 125 at a movable pivot connection that moves with lift arm 125. In one example, the crank arm 130 coupled to the base 105 via a fastener 145 (e.g., a pin, bolt, etc.) arranged through a mounting bracket 505. In one example, the fastener 145 may form a pivot point of the crank arm 130 to facilitate pivotal movement of the crank arm (e.g., as the second end 215 of the lift arm 125 is moved horizontally along the second direction to raise and lower the jack 100).

As mentioned above, similar to the fastener 140, the fastener 145 may permit the crank arm 130 to rotate about an axis (e.g., a third axis) formed by the fastener 145. In one example, the crank arm 130 may rotate about 90-degrees around the fastener 145. In another example, the crank arm 130 may rotate about 60 to about 90-degrees around the fastener 145.

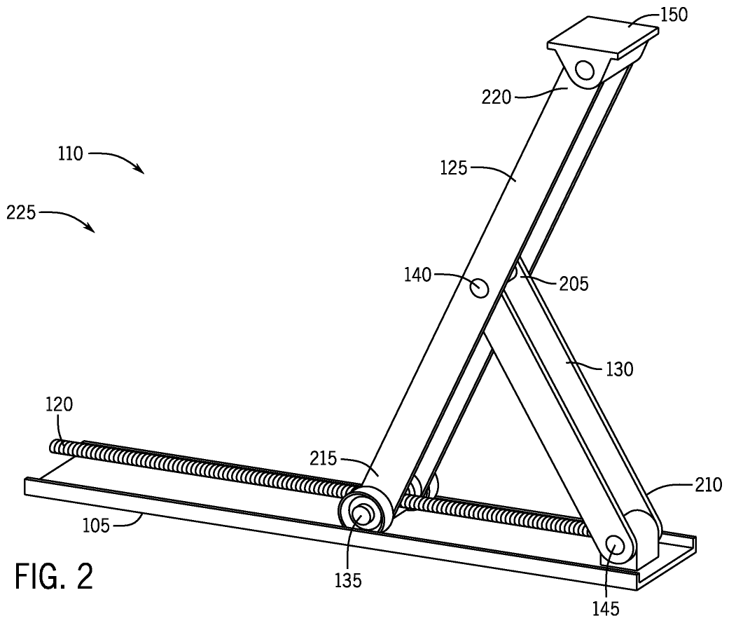

With continued reference to FIGS. 1 and 2, and actuator can be provided to control raising and lowing of the lift mechanism 110. As illustrated, the actuator can be a lead screw 120 and rotation of the lead screw 120 via the drive mechanism 115 may move the lift mechanism 110 between a first, lowered position 165 and a second, raised position 225. In one particular example, the lead screw 120 may be mounted to or through both the lift arm 125 and the crank arm 130. For example, the lead screw 120 may be coupled to the lift arm 125. The lead screw 120 can threadably engage and extend through a drive nut 310 held within a carriage 305 that is secured to the second end 215 of the lift arm 125. In one example, the carriage 305 may secure the wheels 135 to the second end 215 of the lift arm 125 to permit slidable movement between the second end 215 of the lift arm 125 and the base 105. Further, an end of the lead screw 120 may be received within a bracket 505, which may include a thrust bearing to permit rotation of the lead screw 120. The bracket 505 can be provided on the base 105 between the second end 215 of the lift arm 125 and the second end of the crank arm 130. In some cases, the bracket 505 can also define the fixed pivot point to which the crank arm 130 is pivotally coupled. In one example, the lead screw 120 may be a self-locking ACME type lead screw to prevent inadvertent or unwanted lowering of the lift mechanism 110. In other examples, the lead screw 120 may be a square type, trapezoidal type, buttress type or other type of lead screw.

In one example, rotation of the lead screw 120 in a first direction (e.g., clockwise direction) may cause the second end 215 of the lift arm 125 to move (e.g., slide) along the base 105 (e.g., via one or more wheels 135). For example, the wheels 135 may be secured to the carriage 305 so that, as the carriage 305 moves along the lead screw 120 (e.g., via the drive nut 310), the wheels 135 move along the base 105. Thus, as the second end 215 of the lift arm 125 moves horizontally (e.g., in the direction shown by arrow 155) the first end 220 of the lift arm 125 moves vertically (e.g., in the direction shown by arrow 160). As should be appreciated, movement of the first end 220 of the lift arm 125 in the direction shown by arrow 160 may apply an upward or lift force to a vehicle to lift or raise the vehicle. Correspondingly, as the second end 215 of the lift arm 125 moves horizontally (e.g., opposite the direction shown by arrow 155) the first end 220 of the lift arm 125 moves vertically (e.g., opposite the direction shown by arrow 160). More specifically, as the second end 215 of the lift arm 125 moves toward the second end 210 of the crank arm 130, the crank arm 130 constrains the linear movement (e.g., in the direction shown by arrow 155) of the first end 220 of the lift arm 125 due to the pivotal connection via fastener 140. Some of this linear movement (e.g., in the direction shown by arrow 155) is converted into vertical movement of the first end 220 of the lift arm 125 (e.g., in a direction shown by arrow 160). Correspondingly, linear movement (e.g., in the direction shown by arrow 155) of the second end 215 of the lift arm may induce rotation of the lift arm 125 in a first rotational direction about the fastener 140, which induces the vertical movement of the first end 220 of the lift arm 125. At the same time, the crank arm 130 is rotated in a second rotational direction that is opposite the first rotational direction.

As should be appreciated, movement of the first end 220 of the lift arm 125 in the direction opposite that shown by arrow 160 may reduce an upward or lift force applied to the vehicle lower the vehicle. In one example, to distribute load (e.g., across a larger surface area) and to maintain contact between the lift arm 125 and the vehicle during lifting or lowering (e.g., via the larger surface area), the lift arm may include a saddle 150 pivotally mounted to the first end 220 of the lift arm 125 via a fastener 405. In one example, the saddle 150 may be configured to contact the vehicle during lifting or lowering of the vehicle to provide an increased contact area between the jack and the vehicle (e.g., to distribute forces, etc.).

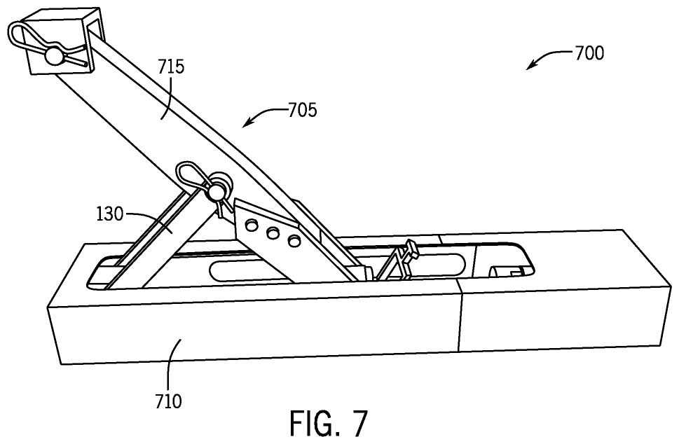

FIGS. 7-12 illustrate another example of a vehicle jack 700 (e.g., as an alternative configuration of the vehicle jack 100). As will be recognized, the vehicle jack 700 shares a number of components in common with and operates in a similar fashion to the examples illustrated and described previously. For the sake of brevity, these common features will not be again described below in detail. Rather, previous discussion of commonly named or numbered features, unless otherwise indicated, also applies to example configurations of the vehicle jack 700.

With reference to FIG. 7, the vehicle jack 700 may include a housing 710 to secure and retain various components of the jack 700. For example, the housing 710 may surround components of the jack 700 to mitigate the intrusion of debris into the jack 700, which may cause premature wear or other unwanted issues. In one example, the housing 710 may be made from a metallic material (e.g., aluminum). However, in other examples, the housing 710 may be made from alternative materials (e.g., a polymeric material). Further, the jack 700 may include a lift mechanism 705, which includes a lift arm 715. The lift arm 715 can have a multi-piece arrangement to facilitate ease of manufacturing of the jack 700.

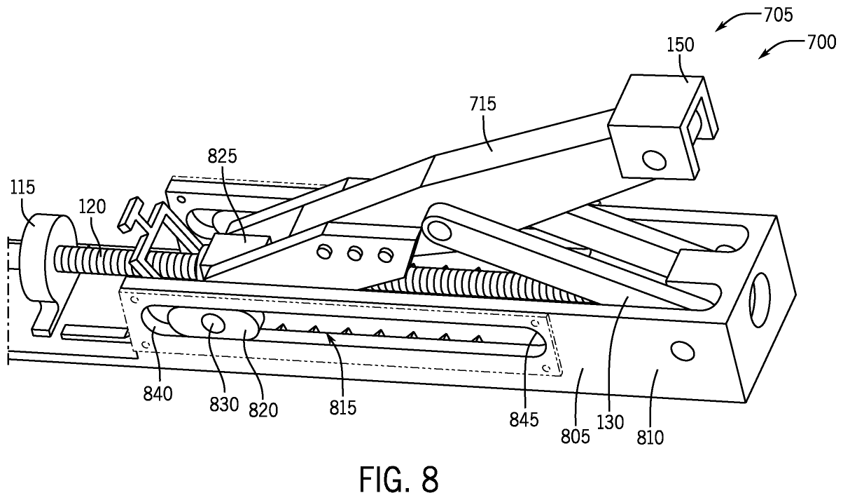

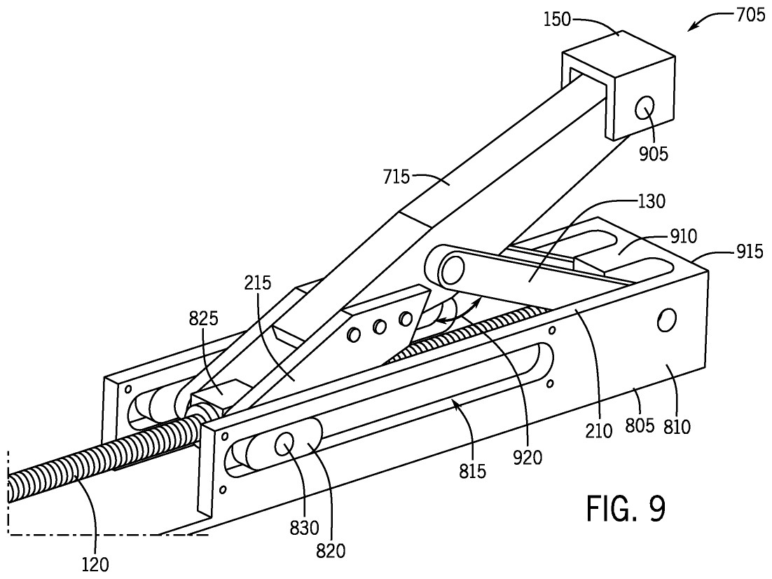

Turning to FIGS. 8 and 9, the vehicle jack 700 may include a base 805 with one or more sidewalls 810 defining elongate slots 815. In one particular example, base 805 may include a pair of opposing sidewalls 810 including one or more slots 815 configured to permit slidable (e.g., linear) movement of one or more sliders 820 within the slots 815. The sliders 820 can be configured as pads or as wheels. Thus, as the lead screw 120 is rotated to raise the lift arm 715, the sliders 820 (e.g., first and second sliders 820) may slide within the slots 815 (e.g., first and second slots 815) from a first end 840 of the slots 815 to a second end 845 of the slots 815. In one particular example, when the slider 820 contacts the first end 840 of the slots 815, the jack 700 may be in the lowered position. Correspondingly, when the slider 820 contacts the second end 845 of the slots 815, the jack 700 may be in the raised position. Thus, the slots 815 may provide a user with a visual or tactile indication of the amount of movement remaining in the jack 700 (e.g., before reaching the lowered or raised positions). Additionally, the slots 815 can define hard stops to prevent overtravel of the jack 700 between the extended and retracted configurations. In some cases, the length and position of the slots 850 can be set to control a minimum and maximum value of an angle 920 between the lift arm 715 and the crank arm 730 (e.g., between the second end 210 of the crank arm 130 and the second end 215 of the lift arm 715), and thereby a maximum and minimum height, respectively, of the lift arm 725. In some cases, it is preferable that the angle 920 has a minimum value ranging from about ten degrees to about twenty degrees (inclusive) to prevent toggling of the linkage (e.g., the lift mechanism 705) or non-linear motion.

To facilitate movement of the sliders 820 within the slots 815, the sliders 820 may be secured to one or more pins 830 (e.g., defining a second axis) extending from opposing ends of a carriage 825 of the lift mechanism 705, to which the lift arm 715 is pivotally coupled. In other examples, the pins 830 can be formed as part of the lift arm 715. The lead screw 120 may extend through the carriage 825 and be engaged with (e.g., threadedly engaged with) the drive nut of the carriage 825 so that rotation (e.g., clockwise rotation) of the lead screw 120 drives the carriage 825 (and thus the sliders 820) towards the second end 845 of the slots 815, which correspondingly moves the jack 700 towards the raised position (e.g., to raise a vehicle). Put differently, as a distance between the second end 215 of the lift arm 715 and the second end 210 of the crank arm decreases, the height (e.g., vertical height) of the first end 220 of the lift arm increases (e.g., approaches the raised position). Correspondingly, as the distance between the second end 215 of the lift arm 715 and the second end 210 of the crank arm 130 increases, the height (e.g., vertical height) of the first end 220 of the lift arm decreases (e.g., approaches the lowered position).

In one example, an end of the lead screw 120 may be secured within a thrust bearing held within a receptacle 910 extending inward from an end wall 915 of the base 805. In one example, the thrust bearing may permit free rotation of the lead screw 120, so that the carriage 825 may translate along the lead screw 120 (and thus move the lift arm 715 between the raised and lowered positions).

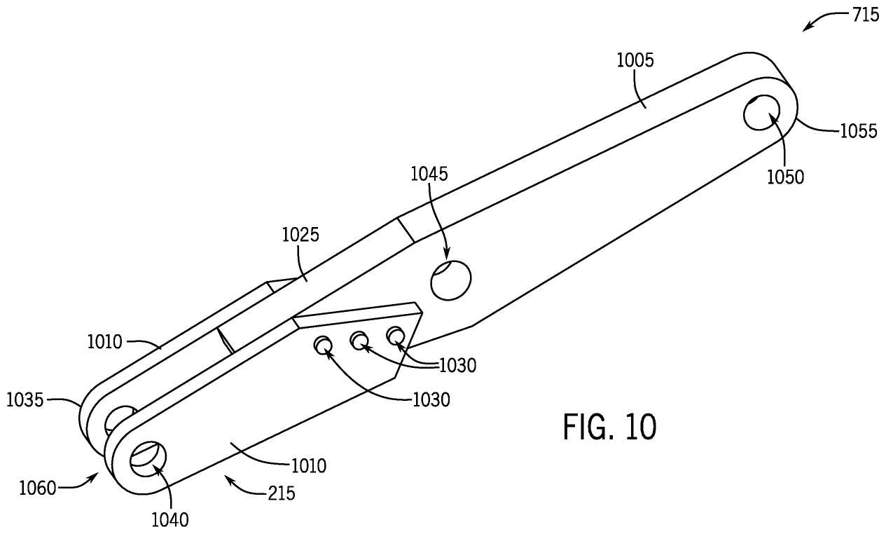

FIG. 10 shows an example of the lift arm 715 of the jack 700. As mentioned previously, to facilitate ease of manufacturing, the lift arm 715 may be a multi-piece lift arm including a main arm 1005 and one or more secondary arms 1010. In one particular example, the lift arm 715 may include a pair of secondary arms 1010 arranged on opposing sides of a first end 1025 of the main arm 1005 (e.g., with the first end 1025 of the main arm 1005 sandwiched between the secondary arms 1010) that may define the second end 215 of the lift arm 715. In one example, to secure the secondary arms 1010 to the main arm 1005, one or more fasteners may be arranged through one or more apertures 1030 extending through the main arm 1005 and the secondary arms 1010. In the illustrated example, three (3) fasteners may be arranged through three (3) apertures 1030. In other examples, the secondary arms 1010 can be formed with the main arm 1005, or the secondary arms 1010 can be secured to the main arm in other ways (e.g., welding, riveting, etc.).

In one example, the lift arm 715 may include a pivot point 1045 (e.g., a mounting location for the crank arm 130) arranged on the main arm 1005 and configured to receive a fastener (e.g., fastener 140) to secure the lift arm 715 to the crank arm 130. In one example, the pivot point 1045 may be arranged at a midpoint (e.g., center) of the lift arm 715 (e.g., bisecting an entire length of the lift arm 715). Correspondingly, ends 1035 of the secondary arms 1010 may form a yoke 1060, which may include apertures 1040 configured to receive the pins 830 extending from the carriage 825 to secure the lift arm 715 to the carriage 825. Further, opposite the ends 1035 of the secondary arms 1010, at an end 1055 of the main arm 1005 is an aperture 1050 configured to receive the pin 905 to secure the saddle 150 to the lift arm 715. In one example, the saddle 150 may be configured to rotate about an axis (e.g., a first axis) defined by the pin 905. Thus, the lift arm 715 is configured to move along with the carriage 825 as the carriage translates along the lead screw 120.

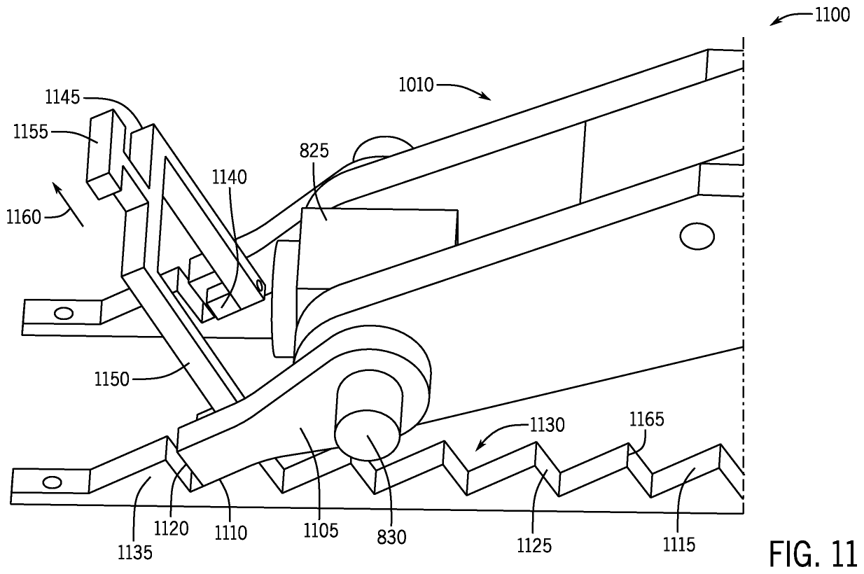

FIG. 11 shows an example of a locking mechanism 1100 for use with the vehicle jack 700. In one example, the locking mechanism 1100 may be used to prevent inadvertent movement (e.g., lowering) of the vehicle jack 700. For example, the locking mechanism 1100 may prevent the jack 700 from moving from the raised position toward the lowered position, without an outside force applied by a user (e.g., operation of the lead screw 120). In one example, the locking mechanism 1100 may include one or more locking pawls 1105, which may be secured to the pins 830 extending from the carriage 825. In one example, as the locking pawls 1105 are secured to the carriage 825 via the pins 830, the pawls 1105 are configured to move along with movement of the carriage 825 (e.g., the pawls, carriage, and second end of the lift arm 715 all move together along the lead screw 120). Thus, in one example, as the carriage 825 translates along the lead screw 120, an end 1110 of the pawl 1105 may move along a sawtooth rack 1135.

In one example, the sawtooth rack 1135 may include a series of cutouts 1130 (e.g., detents) each defined by an angled face 1115 (e.g., a ramped surface) and an angled backstop 1125 (e.g., an engagement surface). As the pawl 1105 is translated with the carriage 825, the end 1110 of the pawl slides along the angled face 1115 of a cutout 1130 until reaching an apex 1165 of the face 1115. Once reaching the apex 1165 of the face 1115, the end 1110 of the pawl 1105 may fall into the next (e.g., sequential) cutout 1130 and repeat the process throughout raising of the lift arm 715. In one example, due to the positioning of the backstop 1125, if the jack 700 were to begin to lower, a tip 1120 of the pawl 1105 would contact the backstop 1125 and prevent further lowering of the jack 700. Put differently, the end 1110 of the pawl 1105 would slide along the angled face 1115 until the tip 1120 of the pawl 1105 contacts the backstop 1125. In one particular example, due to the arrangement of the cutouts 1130, the jack 700 would be permitted to lower no more than about one half-inch before the tip 1120 of the pawl 1105 contacts the backstop 1125. Thus, the locking mechanism 1100 may function as a locking mechanism (e.g., in addition to the self-locking capabilities of the lead screw 120, where provided). Additionally, in a loaded condition of the jack 700, the pawls 1105 may be used to transfer the load into the base 805, reducing forces on the lead screw 120. Accordingly, after raising a load with the jack 700, a user may lower a load slightly to engage the pawls 1105 with the sawtooth rack 1135, or the jack 700 may automatically lower the load so that the pawls 1105 with the sawtooth rack 1135.

To release the locking mechanism 1100 (e.g., permit lowering of the jack 700), the locking mechanism may include a release mechanism 1145. The release mechanism is configured to disengage the pawls 1105 from the sawtooth rack 1135 (e.g., a cutout 1130 thereof) to permit lowering of the lift mechanism 705. For example, the release mechanism 1145 may include one or more legs 1150 secured to protrusions 1140 extending from an inside surface of the pawls 1105. In one example, to release the locking mechanism 1100, an operator may manipulate a release 1155 (e.g., a handle, foot pedal, etc.) of the release mechanism 1145 and apply a force in the direction of arrow 1160. As a result, the ends 1110 of the pawls 1105 may be removed (e.g., lifted) from the cutouts 1130, which in turn permits the jack 700 to move from the raised position to the lowered position. In another example, if the tip 1120 of the pawl 1105 is contacting the backstop 1125, a user may first advance (e.g., raise) the jack 700 to separate the tip 1120 of the pawl 1105 from the backstop 1125 and then actuate the release 1155 to remove the pawls 1105 form the cutouts 1130 and lower the jack 700.

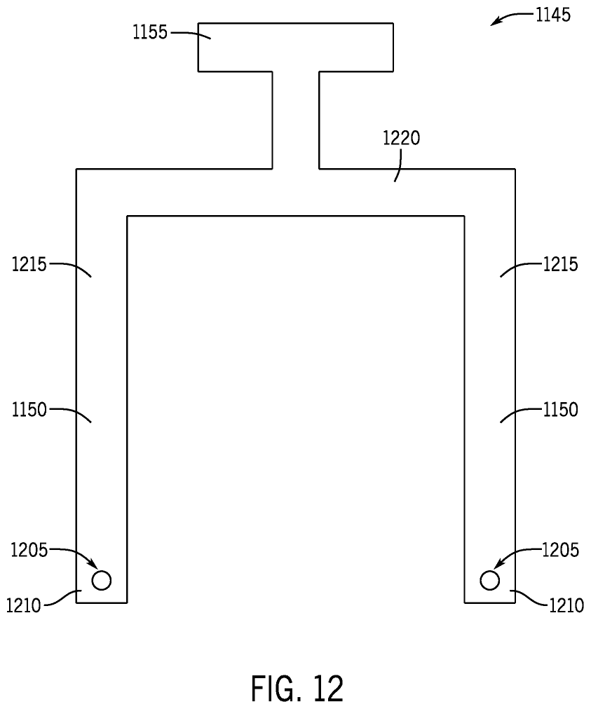

FIG. 12 shows an example of the release mechanism 1145 of the locking mechanism 1100. In one example, as mentioned above, the release mechanism 1145 may be coupled to the pawls 1105. For example, the release mechanism 1145 can be secured to the pawls 1105 via one or more fasteners arranged through one or more apertures 1205 at a first end 1210 of the legs 1150. Correspondingly, the release mechanism 1145 may include a crossmember 1220 extending between the legs 1150, with the crossmember 1220 arranged at a second end 1215 of the legs 1150. Further, to permit an operator to grasp the release mechanism 1145, the release mechanism 1145 may include a release 1155 extending away from a midpoint of the crossmember 1220. In one example, the release 1155 may define a T-shape, while the legs 1150 and the crossmember 1220 define an inverted (e.g., upside-down) U-shape.

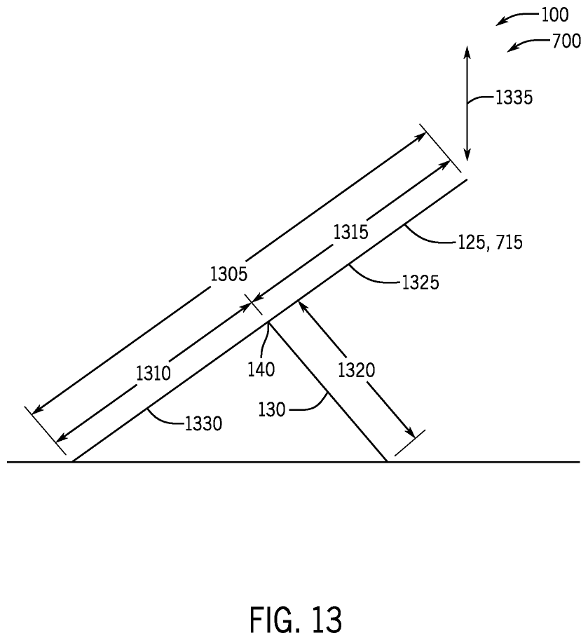

As shown in FIG. 13, the vehicle jacks 100, 700 described above may define a vertical lifting force (e.g., a vertical travel path 1335) for the first end 220 of the lift arms 125, 715 (e.g., including the saddle 150). As should be appreciated, providing a vehicle jack with vertical travel allows a user to accurately position the jack to engage a lift point of a load, while reducing lateral forces on the jack during a lifting operation. To generate vertical travel of the second end of the lift arm (e.g., of a saddle that engages a load), the lift arm may be designed to be about double the length of the crank arm 130. Put differently, the length 1315 of the first leg 1325 must be the same as the length 1320 of the crank arm 130. For example, the lift arms 125, 715 may include a length 1305 that is double a length 1320 of the crank arm. Additionally, the pivot point (e.g., location of the fastener 140 where the crank arm 130 connects to the lift arm) may be positioned at a midpoint (e.g., center) of the lift arm.

This configuration effectively separates the lift arm into two (2) equal length legs (e.g., a first leg 1325 and a second leg 1330), which are each equal to the length of the crank arm 130. Put differently, the crank arm 130 defines a length 1320, which is equal to a length 1315 of a first leg 1325 of the lift arm and equal to a length 1310 of a second leg 1330 of the lift arm. Thus, the first leg 1325, second leg 1330, and the crank arm 130 may each be the same length.

In one particular example, the lift arm may be about fourteen (14) inches in length, with the fastener 140 positioned at the middle of the lift arm. Thus, the first leg 1325 of the lift arm may be seven (7) inches in length and a second leg 1330 of the lift arm may be seven (7) inches in length. Correspondingly, the crank arm may be seven (7) inches in length. Thus, in this configuration, the jack may be able to extend approximately 10 inches overall (e.g., from 6 inches in a lowered position to 16 inches in a raised position). However, in other examples, the length of the lift arm or crank arm may be longer or shorter to increase or decrease an overall extension distance of the jack.

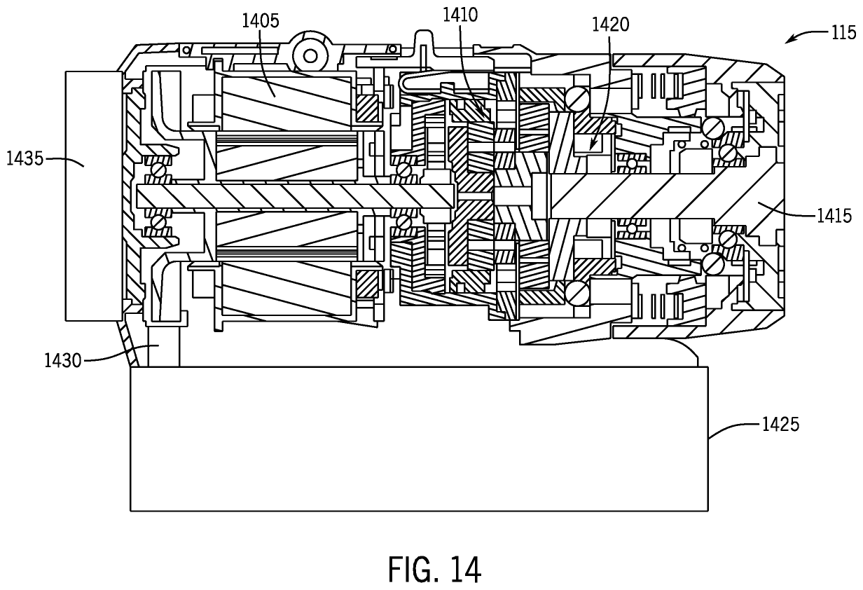

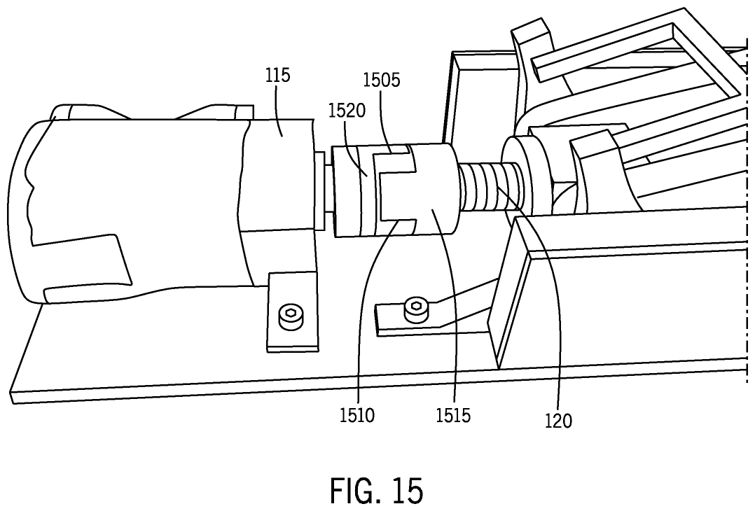

FIGS. 14 and 15 show an example of the drive mechanism 115, which may facilitate rotation of the lead screw 120 and thus raising or lowering of the first end 220 of the lift arm. In one example, the drive mechanism 115 may include an electric motor 1405, which provides rotational force to a spindle 1415 connected to the lead screw 120. However, as shown in FIG. 15, in other examples, the spindle 1415 may be connected to a coupler 1505, which in turn may be connected to the lead screw 120. For example, the coupler 1505 may be a jaw and spider coupling that includes an elastomeric spider 1510 arranged between corresponding first and second components of the coupler 1505. For example, a first component 1515 of the coupler 1505 may be secured to an end of the lead screw 120, while a second component 1520 of the coupler 1505 may be secured to the spindle 1415. Thus, rotational force may be applied to the second component 1520 via the spindle 1415, through the spider 1510, and through the first component 1515 to the lead screw 120. In other examples, other types of rotational couplings can be used, including, for example, collars, chucks, woodruff keys, pins, etc.

In another example, the electric motor 1405 is connected to the spindle 1415 via a transmission 1410 and a clutch 1420. The transmission 1410 and clutch 1420 may transfer power from the electric motor 1405 to the spindle 1415 to rotate the lead screw 120 (e.g., with or without coupler 1505). In one example, the electric motor 1405 may receive input power (e.g., direct current (DC) power) from a battery 1425. In one example, the battery 1425 may be a portable, rechargeable, type battery. In other examples, the battery 1425 may be a disposable type battery. In one example, the battery may be a lithium-ion type battery. In other examples, the electric motor 1405 may receive input power (e.g., alternating current (AC) power) via a cable (e.g., an electrical cable) connected to a wall plug or other power source.

As should be appreciated, in other examples, the battery 1425 may supply power to a controller 1430, which in turn may control operation (e.g., on/off, rotational speed/torque, etc.) of the motor 1405 based on one or more inputs from an operator. For example, an operator may actuate a button, trigger, or other actuation device 1435 to indicate to the controller that activation of the motor 1405 in a first (e.g., forward) direction, and thus raising of the jack, is desired. Correspondingly, an operator may release the button, trigger, or other actuation device 1435 to indicate to the controller that deactivation of the motor 1405, and thus stopping movement of the jack, is desired. Further, the operator may actuate the button, trigger, or other actuation device 1435 to indicate to the controller that activation of the motor 1405 in a second (e.g., reverse) direction, and thus lowering of the jack, is desired.

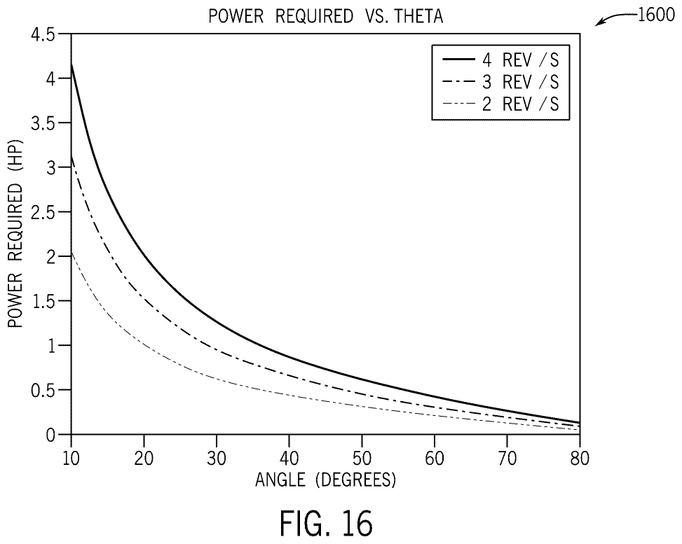

FIGS. 16-18 illustrate various mechanical characteristics of the vehicle jacks 100, 700. For example, as shown in FIG. 16, as a lift angle of the first end 220 of the lift arm increases (e.g., the lift arm moves from a lowered position to a raised position) the power required for the drive mechanism 115 to move (e.g., raise) the second end of the lift arm (e.g., force applied by the drive mechanism 115) decreases. Correspondingly, the amount of power required to raise the second end of the lift arm may be greater at a higher angular speed (e.g., revolutions per second) of the drive mechanism 115 vs. at a lower angular speed.

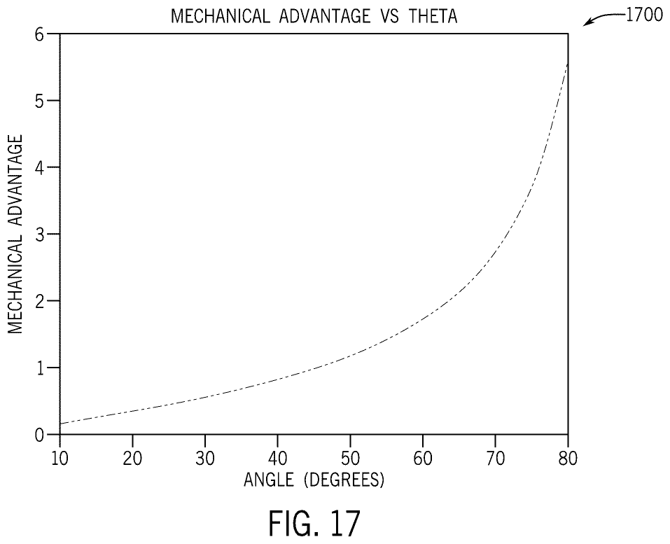

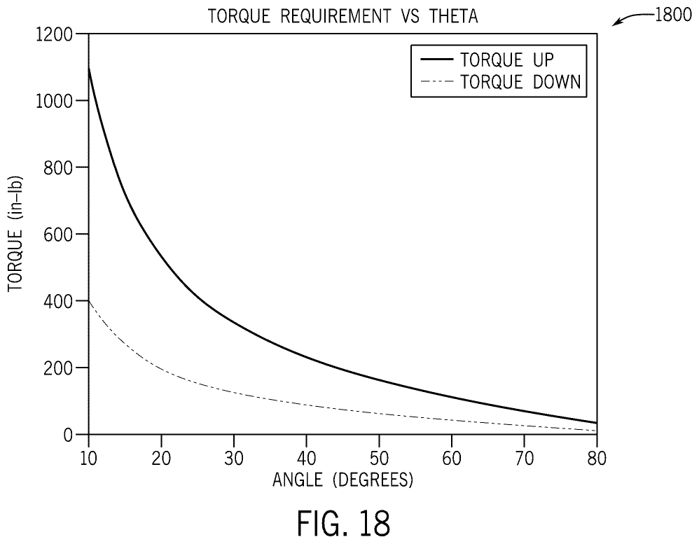

Similarly, as the lift angle of the second end of the lift arm increases (e.g., approaches 90 degrees) the torque (e.g., from the drive mechanism 115) required to move (e.g., raise) the second end of the lift arm decreases (see, e.g., FIG. 18). Correspondingly, as the lift angle of the second end of the lift arm increases (e.g., approaches 90 degrees) the mechanical advantage (e.g., ratio of input force vs. output force) increases. Thus, as the second end of the lift arm 125 approaches a 90-degree lift angle the motor 1405 may supply less power and still lift the vehicle (see, e.g., FIG. 17).

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of. A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than +10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

While the disclosed vehicle jacks have been described with respect to example vehicle jacks, it should be understood that any one or more example embodiments of the disclosed vehicle jacks could be incorporated in alternate forms of a vehicle jack. Furthermore, it should be understood that one or more example embodiments of the disclosed vehicle jacks could be used outside of the context of a vehicle jack and could more generally be used in a mechanism and/or mechanisms that generate/generates lift forces.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A vehicle jack, comprising:
a base;
a lift arm including a first end that engages a load and a second end that is movably coupled to the base;
a crank arm including a third end that is pivotally coupled to the base and a fourth end that is pivotally coupled to the lift arm between the first end and the second end;
an actuator coupled to the lift arm; and
an electric motor to actuate the actuator to move the second end of the lift arm relative to the third end of the crank arm to cause a vertical movement at a first end of the lift arm between a lowered position and a raised position.

2. The vehicle jack of claim 1, wherein the lift arm includes a saddle that is pivotally coupled to the first end of the lift arm to rotate about a first axis, the lift arm is pivotally coupled to the base at the second end to pivot about a second axis, and the lift arm is pivotally coupled to the fourth end of the crank arm to rotate about a fourth axis, the fourth axis being between the first axis and the second axis.

3. The vehicle jack of claim 2, wherein the fourth axis is at a midpoint between the first axis and the second axis.

4. The vehicle jack of claim 2, wherein the second end of the lift arm is pivotally coupled to a carriage that engages the base to provide a sliding motion therebetween.

5. The vehicle jack of claim 4, wherein the actuator is a lead screw and the carriage includes a drive nut, the lead screw extending through the drive nut to engage with a bracket that is pivotally coupled to the third end of the crank arm.

6. The vehicle jack of claim 5, wherein the base includes a sidewall defining an elongate slot that receives a slider that is coupled to the carriage to the second end of the lift arm.

7. The vehicle jack of claim 1, wherein rotation of the actuator generates horizontal movement of the second end of the lift arm relative to the third end of the crank arm, and
wherein an amount of horizontal movement of the second end of the lift arm generates a corresponding amount of vertical movement in the first end of the lift arm.

8. The vehicle jack of claim 1, further comprising a locking mechanism that includes a sawtooth rack coupled to the base and a pawl coupled to the lift arm to ratchetingly engage the sawtooth rack to allow movement of the lift arm toward the raised position and to prevent movement of the lift arm toward the lowered position.

9. The vehicle jack of claim 8, wherein the sawtooth rack includes a plurality of cutouts, each of the plurality of cutouts defining:
a ramped surface to slidably engage the pawl to allow the pawl to move to a subsequent one of the plurality of cutouts as the lift arm moves toward the raised position, and
and an engagement surface configured to engage with the pawl to transfer a load supported by the lift arm to the base and prevent movement of the lift arm toward the lowered position.

10. The vehicle jack of claim 9, wherein the locking mechanism includes a release mechanism to permit an operator to selectively disengage the pawl from the sawtooth rack and allow for movement of the lift arm toward the lowered position.

11. A vehicle jack, comprising:
a base coupled to a battery;
a carriage movably coupled to translate along the base, the carriage include a drive nut;
a saddle configured to engage a vehicle;
a lift arm including a first end pivotally coupled to the saddle to define a first axis and a second end pivotally coupled to the carriage to define a second axis;
a crank arm with a third end that is pivotally coupled to the base to define a third axis and a fourth end that is pivotally coupled to the lift arm to define a fourth axis that is between the first axis and the second axis;
a lead screw threadably engaged with the drive nut; and
an electric motor configured to receive power from the battery and operable rotate the lead screw to adjust an angle between the lift arm and the crank arm to move the vehicle jack between a raised position corresponding to a minimum value of the angle and a lowered position corresponding to a maximum value of the angle.

12. The vehicle jack of claim 11, wherein the fourth axis bisects a length defined between the first axis and the second axis so that rotation of the lead screw generates movement of the carriage along a first direction that corresponds to movement of the saddle along a second direction that is perpendicular to the first direction.

13. The vehicle jack of claim 11, wherein the lead screw includes a first end that is coupled with the electric motor and a second end that is coupled to a thrust bearing that is provided in a bracket of the base that pivotally couples to the crank arm.

14. The vehicle jack of claim 13, the first end of the lead screw is coupled to the electric motor via a rotational coupler.

15. The vehicle jack of claim 11, wherein the second end of the lift arm defines a yoke that receives the carriage.

16. The vehicle jack of claim 15, wherein the carriage includes a first pin that extends through a first arm of the yoke to couple with a first pad and a second pin that extends through a second arm of the yoke to couple with a second pad.

17. The vehicle jack of claim 16, wherein the base includes a first sidewall with a first slot to receive the first pad and a second sidewall with a second slot to receive the second pad, the first slot and the second slot configured to restrict movement of the second end of the lift arm to maintain the angle between the minimum value of the angle and the maximum value of the angle, the lift arm positioned between the first sidewall and the second sidewall.

18. A vehicle jack, comprising:
a base coupled to a battery, the base including a first sidewall defining a first slot, a second sidewall defining a second slot, and a bracket between the first sidewall and the second sidewall;
a carriage movably coupled to translate along the base, the carriage include a drive nut, a first pad that is received in the first slot, and a second pad that is received in the second slot;
a saddle configured to engage a vehicle;
a lift arm positioned between the first sidewall and the second sidewall, the lift arm including a first end pivotally coupled to the saddle to define a first axis and a second end defining a yoke that is pivotally coupled to the carriage to define a second axis;
a crank arm with a third end that is pivotally coupled to the bracket and a fourth end that is pivotally coupled to the lift arm to define a fourth axis that is between the first axis and the second axis,
a lead screw threadably engaged with the drive nut the lead screw having a first end that is rotatably coupled to the bracket; and
an electric motor configured to receive power from the battery and coupled to a second end of the lead screw to rotate the lead screw to adjust to cause a vertical movement at a first end of the lift arm between a lowered position corresponding to a maximum angle between the lift arm and the crank arm and a raised position corresponding to a minimum angle between the lift arm and the crank arm.

19. The vehicle jack of claim 18, further comprising:
a sawtooth rack coupled to the base between the lift arm and at least one of the first sidewall and the second sidewall; and
a pawl pivotally coupled to the second end of the lift arm to selectively engage and disengaged with the sawtooth rack, the pawl allowing movement of the lift arm toward a lowered position when disengaged with the sawtooth rack, and the pawl allowing ratcheting movement of the lift arm toward the raised position and preventing movement of the lift arm toward the lowered position when engaged with the sawtooth rack.

20. The vehicle jack of claim 18, wherein a first length between the first axis and the fourth axis is equal to each of a second length between the second axis and the fourth axis and a third length between the third axis and the fourth axis.
